(19) United States
(12) Patent Application Publication
(10) Pub. No.: US 2016/0080123 A1
(43) Pub. Date: Mar. 17, 2016

(54) Inter-eNB Signaling for Fast Muting Adaptation

(71) Applicant: NOKIA SOLUTIONS AND NETWORKS OY, Espoo (FI)

(72) Inventors: Klaus Ingemann PEDERSEN, Aalborg (DK); Beatriz SORET, Aalborg (DK)

(21) Appl. No.: 14/889,161

(22) PCT Filed: Mar. 13, 2014
(86) PCT No.: PCT/EP2014/054953

§ 371 Date: Nov. 5, 2015

(51) Int. Cl. H04L 5/00

(52) U.S. Cl. CPC H04L 5/0032; H04L 5/0085; H04L 5/0073

(57) ABSTRACT

First almost-blank subframe, ABS, information regarding multiple subframes, SFs, is received at an underlying access point, AP, from an overlaying AP, wherein the first ABS information includes an identification of mandatory ABS(s) in the multiple SFs. Second ABS information regarding the multiple SFs is received at the underlying AP from the overlaying AP. The second information includes an identification of optional ABS(s) in the multiple SFs. The optional ABS(s) are to be used as one of normal SFs or mandatory ABSs. The multiple SFs for the underlying cell are scheduled based on whether the optional ABS(s) is to be used as an ABS. Mandatory and optional ABSs in multiple subframes are scheduled at an overlaying AP. First ABS information, including an identification of mandatory ABS(s), is sent to an underlying AP. Second ABS information, including identification of optional ABS(s) in the subframes, is sent to the underlying AP.

### TECHNICAL FIELD

The exemplary and non-limiting embodiments relate generally to wireless communication systems, methods, devices and computer programs and, more specifically, relate to inter-eNB signaling for co-channel cell deployments.

### BACKGROUND

This section is intended to provide a background or context. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Heterogeneous networks (HetNets) are utilized to increase traffic capability in congested areas. In these networks, an “overlay” cell (such as a macro cell), with a higher power and a larger coverage area, is complemented with “underlay” cells (such as pico cells) having lower power and smaller coverage areas than the macro cell, but underlying some portion of the macro cell. The lower power cells reduce demands on the macro cell, while, at the same time, providing additional traffic capacity.

A common occurrence when a set of “underlay” cells (or pico cells) is deployed in the coverage area of an “overlay” cell (or macro cell) is that a given pico cell will underlie portions of more than one macro cell, and will then experience interference from more than one macro cell. In such a situation, the amount of interference experienced by the given pico cell from each of the different macro cells may differ. This variation may depend on a number of factors, such as the topology, and the number of UEs in the coverage area of a given pico cell at a given time.

Almost Blank Subframes (ABS) are used for minimizing inter-cell interference. Almost Blank Subframes are subframes with reduced transmit power (including no transmission) on some physical channels and/or reduced activity. For instance, an ABS only contains some necessary signals with low power, such as PSS/SSS (primary and secondary synchronization signals, respectively), PBCH (physical broadcast channel), CRS (cell-specific reference signal), paging, and SIB1 (system information block 1), for compatibility with UEa in 3GPP Release 8/9. Using this technique, some cells (such as a pico cell for example) are muted in certain subframes, so that other cells (such as the macro cell and/or another pico cell for example) can have relatively interference-free spectrum.

### SUMMARY

This section contains examples of possible implementations and is not meant to be limiting.

In an exemplary embodiment, a method comprises receiving, at an underlying access point from an overlaying access point, first almost-blank subframe information regarding a plurality of subframes. The first almost-blank subframe information includes an identification of at least one mandatory almost-blank subframe in the plurality of subframes. The method includes receiving, at the underlying access point from the overlaying access point, second almost-blank subframe information regarding the plurality of subframes. The second almost-blank subframe information includes an identification of at least one optional almost-blank subframe in the plurality of subframes.

The optional almost-blank subframes are to be used as one of normal subframes or mandatory almost-blank subframes by the overlaying and underlying access points. The method further includes scheduling the plurality of subframes for the underlying cell based at least in part on whether the at least one optional almost-blank subframe is to be used as an almost-blank subframe.

An exemplary apparatus comprises: means for receiving, at an underlying access point from an overlaying access point, first almost-blank subframe information regarding a plurality of subframes, wherein the first almost-blank subframe information includes an identification of at least one mandatory almost-blank subframe in the plurality of subframes; means for receiving, at the underlying access point from the overlaying access point, second almost-blank subframe information regarding the plurality of subframes, wherein the second almost-blank subframe information includes an identification of at least one optional almost-blank subframe in the plurality of subframes, wherein the optional almost-blank subframes are to be used as one of normal subframes or mandatory almost-blank subframes by the overlaying and underlying access points; and means for scheduling the plurality of subframes for the underlying cell based at least in part on whether the at least one optional almost-blank subframe is to be used as an almost-blank subframe.

An exemplary apparatus includes one or more processors and one or more memories including computer program code. The one or more memories and the computer program code are configured to, with the one or more processors, cause the apparatus to perform at least the following: receiving, at an underlying access point from an overlaying access point, first almost-blank subframe information regarding a plurality of subframes, wherein the first almost-blank subframe information includes an identification of at least one mandatory almost-blank subframe in the plurality of subframes; receiving, at the underlying access point from the overlaying access point, second almost-blank subframe information regarding the plurality of subframes, wherein the second almost-blank subframe information includes an identification of at least one optional almost-blank subframe in the plurality of subframes, wherein the optional almost-blank subframes are to be used as one of normal subframes or mandatory almost-blank subframes by the overlaying and underlying access points; and scheduling the plurality of subframes for the underlying cell based at least in part on whether the at least one optional almost-blank subframe is to be used as an almost-blank subframe.

Another exemplary embodiment is a method, comprising scheduling mandatory almost-blank subframes in a plurality of subframes and sending, to an underlying access point from an overlaying access point, first almost-blank subframe information regarding the plurality of subframes. The first almost-blank subframe information comprises an identification of the mandatory almost-blank subframes. The method further comprises scheduling optional almost-blank subframes in the plurality of subframes. The optional almost-blank subframes are to be used as one of normal subframes or mandatory almost-blank subframes by the overlaying and underlying access points. The method includes sending, to the underlying access point from the overlaying access point, second almost-blank subframe information regarding the plurality of subframes. The second almost-blank subframe information comprises identification of at least one optional almost-blank subframe in the plurality of subframes.

An exemplary apparatus includes one or more processors and one or more memories including computer program code. The one or more memories and the computer program code are configured to, with the one or more processors, cause the apparatus to perform at least the following: scheduling mandatory almost-blank subframes in a plurality of subframes; sending, to an underlying access point from an overlaying access point, first almost-blank subframe information regarding the plurality of subframes, wherein the first almost-blank subframe information comprises an identification of the mandatory almost-blank subframes; scheduling optional almost-blank subframes in the plurality of subframes, wherein the optional almost-blank subframes are to be used as one of normal subframes or mandatory almost-blank subframes by the overlaying and underlying access points; and sending, to the underlying access point from the overlaying access point, second almost-blank subframe information regarding the plurality of subframes, where the second almost-blank subframe information comprises identification of at least one optional almost-blank subframe in the plurality of subframes.

In another exemplary embodiment, an apparatus comprises: means for scheduling mandatory almost-blank subframes in a plurality of subframes; means for sending, to an underlying access point from an overlaying access point, first almost-blank subframe information regarding the plurality of subframes, wherein the first almost-blank subframe information comprises an identification of the mandatory almost-blank subframes; means for scheduling optional almost-blank subframes in the plurality of subframes, wherein the optional almost-blank subframes are to be used as one of normal subframes or mandatory almost-blank subframes by the overlaying and underlying access points; and means for sending, to the underlying access point from the overlaying access point, second almost-blank subframe information regarding the plurality of subframes, where the second almost-blank subframe information comprises identification of at least one optional almost-blank subframe in the plurality of subframes.

Another exemplary embodiment is a communication system comprising the apparatus in accordance with any one of the examples presented above or herein.

A further exemplary embodiment is a computer program comprising program code for executing the method according to any of the examples presented above or herein. The computer program according to this paragraph, wherein the computer program is a computer program product comprising a computer-readable medium bearing computer program code embodied therein for use with a computer.

### BRIEF DESCRIPTION OF THE DRAWINGS

The foregoing and other aspects of exemplary embodiments are made more evident in the following Detailed Description, when read in conjunction with the attached Drawing Figures, wherein:

FIG. 1 is a logic flow diagram that illustrates the operation of an exemplary method, and a result of execution of computer program instructions embodied on a computer readable memory, in accordance with various exemplary embodiments.

FIG. 2 illustrates a simplified diagram of an inter-eNB network in accordance with various exemplary embodiments.

FIG. 3 demonstrates a simplified signaling exchange in an inter-eNB network.

FIG. 4 demonstrates another simplified signaling exchange in an inter-eNB network in accordance with various exemplary embodiments.

FIG. 5 shows a simplified block diagram of exemplary electronic devices that are suitable for use in practicing various exemplary embodiments.

### DETAILED DESCRIPTION OF THE DRAWINGS

Various exemplary embodiments are described in regards to LTE inter-eNB signaling (such as scenarios with 3GPP Rel-12 enhanced inter-cell interference coordination (eICIC) for co-channel macro+small cell deployments), in particular, regarding fast muting decisions for the almost blank subframes (ABS) taken in the macro layer. For every scheduling interval the macro cell (or overlaying cell) decides if subframes are to be muted or used for normal transmission. If the macro is using normal transmission, macro-users can be scheduled. Otherwise, no macro-users are schedulable. The small-cell-users (such as those on an underlying, pico cell) are scheduled in each of their cells based on whether the users are subject to macro-interference or not. In order to support these fast muting decisions, some extra inter eNB-signaling is used.

Various exemplary embodiments provide a method, apparatus and computer program(s) for inter-eNB signaling for co-channel cell deployments.

As stated above, an “overlay” cell (such as a macro cell), with a higher power and a larger coverage area, is complemented with “underlay” cells (such as pico cells) having lower power and smaller coverage areas than the macro cell, but underlying some portion of the macro cell. That is, there is some or complete overlap between the overlaying cell and the underlying cell. As used herein, an access point that creates an underlying cell is called an underlying access point, and an access point that creates an overlaying cell is called an overlaying access point.

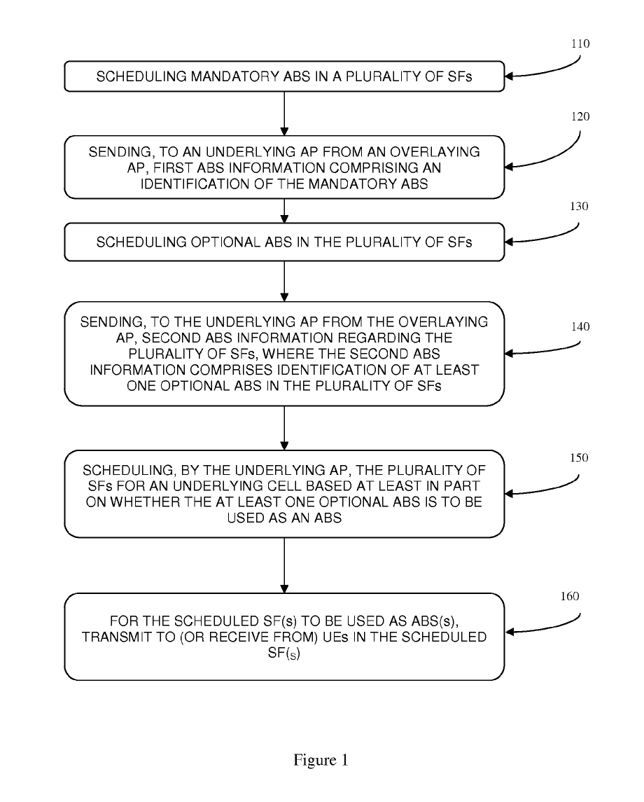

FIG. 1 is a logic flow diagram that illustrates the operation of a method, and a result of execution of computer program instructions, in accordance with exemplary embodiments. In accordance with these exemplary embodiments a method performs, at Block 110, a step of scheduling mandatory ABSs in a plurality of SFs. At Block 120, the method performs a step of sending, to an underlying AP from an overlaying AP, first ABS information comprising an identification of the mandatory ABSs. The first ABS information is any information that at least identifies the mandatory ABSs, examples of which are described below. Optional ABSs in the plurality of SFs are scheduled at Block 130 and second ABS information regarding the plurality of SFs are sent to the underlying AP from the overlaying AP. The second ABS information includes identification of at least one optional ABS in the plurality of SFs at Block 140. The second ABS information is any information that at least identifies the optional ABS(s), examples of which are described below. The method also performs, at Block 150, a step of scheduling, by the underlying AP, the plurality of SFs for an underlying cell based at least in part on whether the at least one optional ABS is to be used as an ABS. A SF for an optional ABS may be used as a normal SF or as a mandatory SF. If the SF for an optional ABS is used as a normal SF by the overlaying AP, the overlaying AP will transmit to (or receive from) UEs normally. The underlying AP can also schedule UEs such that the underlying AP transmits to (or receives from) UEs in the underlying cell, but typically the UEs have to be fairly close to the underlying AP such that the UEs can tolerate the interference from the overlaying AP. If the SF for an optional ABS is used as a mandatory ABS by the overlaying AP, the overlaying AP will transmit an ABS and the underlying AP will transmit to (or receive from) the scheduled UEs. Therefore, in Block 160, the underlying AP, for the scheduled SF(s) to be used as ABS(s), transmits to (or receives from) UEs in the scheduled SF(s).

The various blocks shown in FIG. 1 may be viewed as method steps, and/or as operations that result from operation of computer program code, and/or as a plurality of coupled logic circuit elements constructed to carry out the associated function(s).

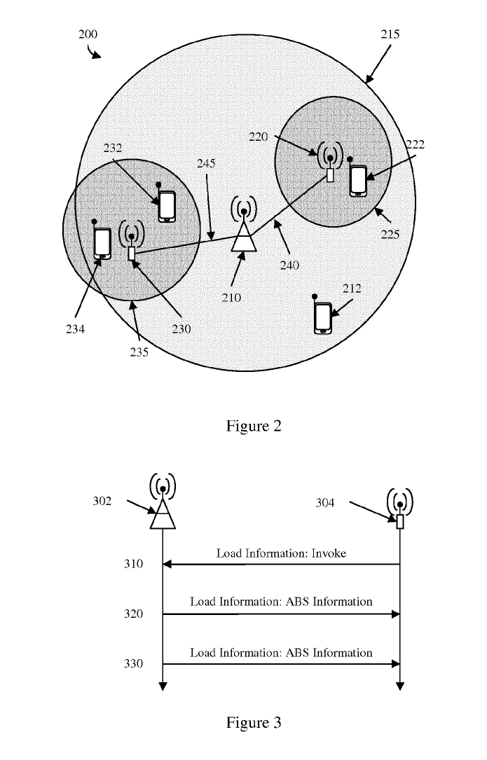

FIG. 2 illustrates a wireless communication system 200 in accordance with various exemplary embodiments. A macro eNB 210 provides a macro cell 215 which includes pico cell 225 and pico cell 235. The macro eNB 210 serves UE 212. In pico cell 225, pico eNB 220 serves UE 222 and in pico cell 235, pico eNB 230 serves UE 232 and UE 234. The macro eNB 210 can communicate to the pico eNB 220 using X2 connection 240 and communicate to the pico eNB 230 using X2 connection 245.

When using mechanisms for distributed dynamic configuration of ABS muting patterns, the macro cell acts as the master and decides which subframes are configured as ABS. The X2 application protocol may be expanded to facilitate collaborative configuration of ABS muting patterns between eNBs.

FIG. 3 is a simplified signaling diagram between a macro eNB 302 and a pico eNB 304. At time 310, the pico eNB 304 requests ABS information from the macro eNB 302. This is performed by sending a “Load information: Invoke” message. The macro eNB 302 may then decide to start using ABS and sends ABS information to the pico eNB 304 at time 320. The macro eNB 302 may decide to use new ABS information (such as based on the load conditions in the pico cell for example) and, at time 330, sends the new ABS information to the pico eNB 304.

As one non-limiting example, the pico eNB 304 can send a Load Information X2 message to a macro eNB 302 with a information element (IE) invoke. The invoke message indicates to the macro eNB 302 that the pico eNB 304 would like to receive ABS information from the macro eNB 302 (potentially with more subframes configured with ABS). The macro eNB 302 responds to such a message by sending another X2 load information message to the pico eNB 304 with IE ABS information. The ABS information includes information of the currently used ABS muting pattern at the macro eNB 302. The ABS information may include a periodically repeated ABS pattern in the macro eNB 302 (such as, one expressed with a 40 bit string for example). Based on the current conditions, the macro eNB 302 determines the consequences of configuring more or less subframes as ABS, before selecting a new ABS muting pattern (or deciding to use the same pattern). Whenever the macro eNB 302 decides to change the ABS muting pattern it informs the pico eNB 304 (and/or any additional eNBs in the macro cell coverage area).

A semi-static configuration of the ABS pattern can be updated on a slow time scale of several seconds. However, fast muting adaptation on a transmission time interval (TTI) basis can significantly improve the performance.

Using optional ABS, the macro eNB can update the ABS pattern shortly before the beginning of a subframe in order to use optional ABS as either a normal subframe or a mandatory ABS. While a minimum number of normal subframes and mandatory ABS may be kept in order to reuse the UE measurement restriction mechanism, the optional ABS provide additional flexibility to quickly adjust which optional subframes are to be used as normal subframes or mandatory ABS. The macro eNB can inform the small cell eNB so that the small cell eNB can know when the macro is using normal, mandatory and optional ABS, and how the next optional ABS will be used. In exchange, the macro eNB collects cell condition information from the pico eNB in order to better decide on the optional subframes.

Thus, the macro eNB provides specific inter-cell signaling to facilitate fast and efficient ABS adaptation. In particular, fast ABS adaption may work in distributed system architecture with macro and pico eNBs without a centralized controller.

Using various exemplary embodiments, the small cell eNB is informed of when the macro is using normal, mandatory and optional ABS, and how the next optional subframe(s) will be configured at the macro (such as for ABS or normal transmission).

The small cell eNB is informed of when the macro is using normal, mandatory and optional ABS when the macro eNB sends a message with the configuration of normal, mandatory, and optional ABS. In addition to the current ABS pattern consisting of a 40-bit string where a “zero” denotes normal transmission and a “one” denotes mandatory ABS (as a non-limiting example), a second 40-bit string for the optional pattern may also be sent. In this second 40-bit string a “zero” denotes that the subframe is not optional and a “one” denotes that the subframe is optional and may be adjusted on a fast basis as either ABS or normal transmission by the macro. The small cell knows that the configured mandatory ABS and normal subframes in the ABS pattern are semi-statically, and thus can use this information to configure corresponding measurements (such as channel state information (CSI) feedback for the users that the small cell is serving).

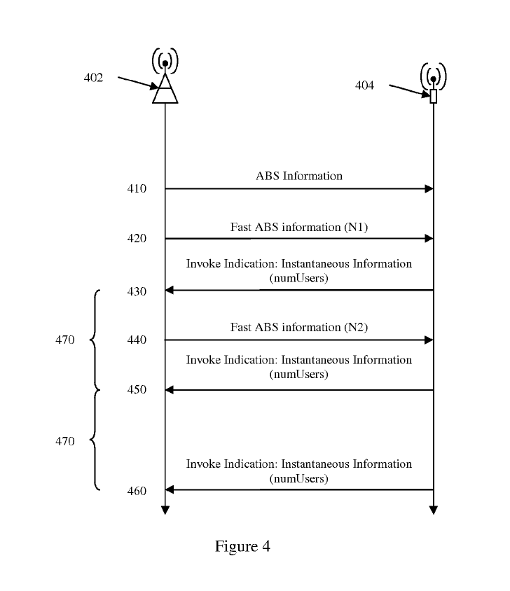

FIG. 4 is another simplified signaling diagram in accordance with various exemplary embodiments. In order to signal the optional subframe configuration, the macro eNB can signal how the next, N, optional subframes are configured. This can be performed by simply providing the number with an implicit configuration (such as where the macro eNB indicates where the option ABS are used as mandatory ABS) or by providing both the number N and an indication of the configuration (either mandatory ABS or normal subframe).

A small cell eNB can send information to the macro eNB on its current cell load, average channel conditions and/or any other information that can help the macro on making the decision on the muting. This information can then be used as input in a specific algorithm applied in the macro layer for the fast muting adaptation. The cell condition information may include the number of users in the small cell in the range extended area, an average proportional fair (PF) metric of the small cell users conditioned on ABS being used at the macro, etc. The small cell eNB can send the cell condition information to the macro eNB on a periodic basis and/or on an event triggered basis (such as every time a significant change has occurred).

As shown in FIG. 4, a macro eNB 402 communicates with a pico eNB 404 in order to signal for co-channel cell deployments. At time 410 the macro eNB 402 provides ABS information to the pico eNB 404. This ABS information may be a semi-static configuration (such as one lasting an indefinite length of time or one with expiration for example). This ABS information includes an indication of option ABS. Then, at time 420, the macro eNB 402 sends fast ABS information (such as a number of subframes, N1, which are to be used as ABS). Later at time 430, the pico eNB 404 sends cell condition information (such as a number of users, numUsers, in the pico cell). This cell condition information may be sent on a periodic basis and/or based on various events (such as when the cell conditions change sufficiently, in response to a request for cell condition information, etc.). At time 440, the macro eNB 402 sends new fast ABS information (such as another number of subframes, N2, which are also to be used as ABS).

As shown, the pico eNB 404 sends cell condition information on a periodic basis after duration time 470. Accordingly, the pico eNB 404 sends cell condition information at time 450 and then again at time 460 (even if no additional fast ABS information is provided).

The load information message (see, e.g., 3GPP TS 36.423 V11.4.0 (2013-03), section 9.1.2.1, describing the “Load Information” message) can be extended to include the proposed enhancements as a new/modified Information Element (such as “Fast ABS Information”):

| | | | | | | |
|---|---|---|---|---|---|---|
| | | | IE type and | Semantics | | Assigned |
| IE/Group Name | Presence | Range | reference | description | Criticality | Criticality |

| | |
|---|---|
| >>Fast ABS | O |
| Information | |

The “0” for presence means the presence of Fast ABS Information is optional.

An “ABS information” information element (see, e.g., 3GPP TS 36.423 V11.4.0 (2013-03), section 9.2.54, describing the “ABS Information” element) may include fields with the optional ABS patterns (e.g., second ABS information). In this case, there are a number of fields for each of FDD and TDD, and the “Optional ABS Pattern Info” is defined for each of FDD and TDD; note that the original ABS Pattern info (e.g., first ABS information) for both FDD and TDD is also shown for clarity:

| IE/Group | | IE type and | |
|---|---|---|---|
| Name | Presence | reference | Semantics description |
| >FDD | | | |
| >>ABS | M | BIT | Each position in the bitmap represents a DL |
| Pattern Info | | STRING | subframe, for which value “1” indicates ‘ABS’ and |
| | | (SIZE(40)) | value “0” indicates ‘non ABS’. |
| | | | The first position of the ABS pattern corresponds |
| | | | to subframe 0 in a radio frame where SFN = 0. |
| | | | The ABS pattern is continuously repeated in all |
| | | | radio frames. |
| | | | The maximum number of subframes is 40. |
| >>Optional | O | BIT | Each position in the bitmap represents a DL |
| ABS | | STRING | subframe, for which value “1” indicates |
| Pattern Info | | (SIZE(40)) | ‘optional ABS’ and value “0” indicates ‘non |
| | | | optional ABS’. |
| | | | The optional ABS pattern has the same size |
| | | | and periodicity as ABS Pattern Info |
| >TDD | | | |
| >>ABS | M | BIT | Each position in the bitmap represents a DL |
| Pattern Info | | STRING | subframe for which value “1” indicates ‘ABS’ and |
| | | (1 . . . 70, . . . ) | value “0” indicates ‘non ABS’. |
| | | | The maximum number of subframes depends on |
| | | | UL/DL subframe configuration. |
| | | | The maximum number of subframes is 20 for |
| | | | UL/DL subframe configuration 1~5; 60 for UL/DL |
| | | | subframe configuration 6; 70 for UL/DL subframe |
| | | | configuration 0. |
| | | | UL/DL subframe configuration defined in TS |
| | | | 36.211 [10]. |
| | | | The first position of the ABS pattern corresponds |
| | | | to subframe 0 in a radio frame where SFN = 0. |
| | | | The ABS pattern is continuously repeated in all |
| | | | radio frames, and restarted each time SFN = 0. |
| >>Optional | O | BIT | Each position in the bitmap represents a DL |
| ABS | | STRING | subframe for which value “1” indicates |
| Pattern Info | | (1 . . . 70, . . . ) | ‘optional ABS’ and value “0” indicates ‘non |
| | | | optional ABS’. |
| | | | The optional ABS pattern has the same size |
| | | | and periodicity as ABS Pattern Info |

The “non-optional ABS” may include mandatory ABS or normal ABS.

In addition, a new information element denoted “Fast ABS Adaptation” may include the value N of a fast ABS adaptation which expresses that the next N optional subframes are configured as ABS by the macro eNB. This offers inter-eNB signaling for fast toggling of optional subframes (as either ABS or normal transmission).

The information element, N, includes the number of the following optional subframes that will be used as ABS (where “M” indicates the presence is mandatory):

| IE/Group | | | IE type and | |
|---|---|---|---|---|
| Name | Presence | Range | reference | Semantics description |
| N | M | | INTEGER | — |

As an example, if the optional ABS pattern information indicates 101101 (where “1”=optional ABS), and N=3, then (at least) the “first”, “third” and “fourth” subframes would be used as ABS subframes. Also, if there are 40 subframes in a frame and the pico eNB receives the Information element N in the 20th subframe, then the N starts (assuming nothing is done in the 20th subframe) at the 21st subframe.

The information element “invoke indication” (see, e.g., 3GPP TS 36.423 V11.4.0 (2013-03), section 9.2.55, which describes the “Invoke Indication” IE) can include updated load information to be provided to the macro eNB for the fast muting adaptation algorithm. As a first, non-limiting example the load information (or cell condition information) may include a number of small cell users, numUsers, in severe interference conditions (such as users in an extended area). With this information the macro can allocate the proper percentage of ABS resources based on instantaneous or short-term load conditions. As a first, non-limiting example the load information may include an average of the PF metric in the small cell layer, AveragePF. The macro can then use the average of the PF metric in the small cell as an indicator of the conditions in the cell. For example, the macro may allocate more ABS resources if the average PF metric in the small cell increases (indicating when the performance deteriorates).

These information elements may be listed as:

| | | | IE type and | Semantics |
|---|---|---|---|---|
| IE/Group Name | Presence | Range | reference | description |
| Invoke Indication | M | | ENUMERATED | — |
| | | | (ABS | |
| | | | Information, . . . ) | |
| Instantaneous | O | | ENUMERATED | |
| Information | | | (NumUsers, | |
| | | | AveragePF, . . . ) | |
| NumUsers | O | | INTEGER 1-100 | |
| AveragePF | O | | INTEGER 1-100 | |

The small cell eNB can choose between sending the information periodically (which should be fast enough/often enough to allow the macro to adapt to the new conditions in sufficient time) or event-triggered (such as every time a significant variation in an indicator has occurred). As examples of significant variations, a significant variation may be triggered in response to a new user arriving or a user ending transmission. An example of the dynamics of the signaling is where the small cell sends updates periodically with the number of users in severe interference conditions (e.g., interference conditions above a predetermined criterion).

Traditional approaches provide fast ABS adaptation using a centralized architecture with macro and remote radio heads (RRHs). For example, the macro eNB may be responsible to perform all baseband processing for the macro and RRHs. In particular, the macro eNB jointly schedules all users in the cluster comprising the macro eNB and all RRHs in its coverage area. In contrast, using specific inter-cell signaling facilitates fast and efficient ABS adaptation for distributed system architecture. More specifically, using X2 signaling allows fast ABS adaption to work in a distributed system architecture with macros and picos.

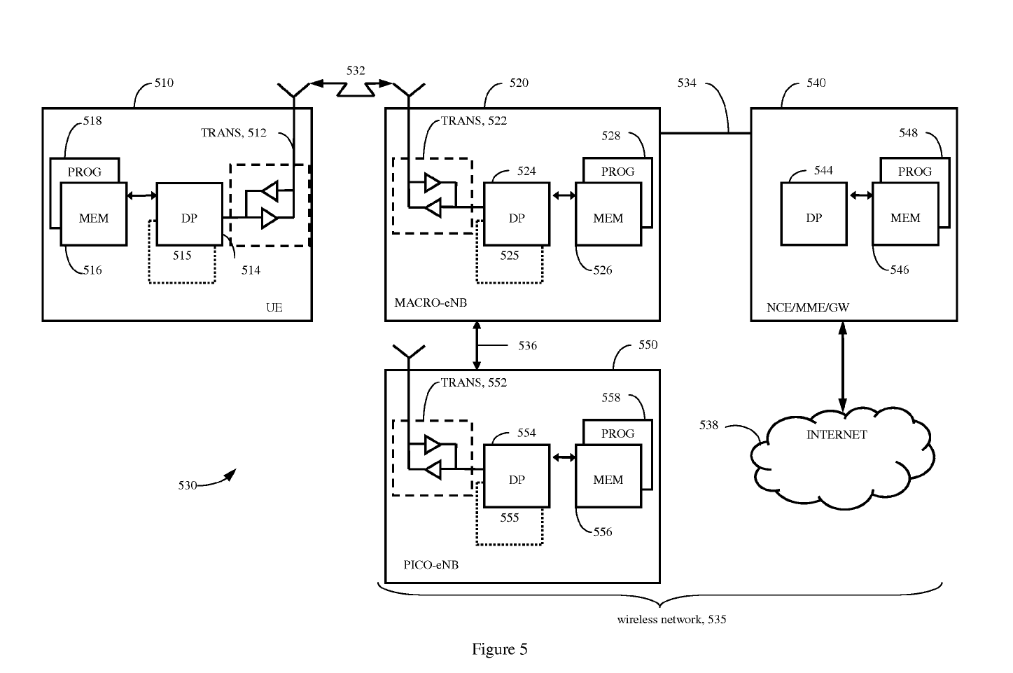

Reference is made to FIG. 5 for illustrating a simplified block diagram of various electronic devices and apparatus that are suitable for use in practicing exemplary embodiments.

In the wireless system 530 of FIG. 5, a wireless network 535 is adapted for communication over a wireless link 532 with an apparatus, such as a mobile communication device which may be referred to as a UE 510, via a network access node, such as a Node B (base station), and more specifically a macro eNB 520. The network 535 may include a network control element (NCE) 540 that may include MME/SGW functionality shown, and which provides connectivity with a network, such as a telephone network and/or a data communications network (e.g., the internet 538).

The UE 510 includes a controller, such as a computer or a data processor (DP) 514, a computer-readable memory medium embodied as a memory (MEM) 516 that stores a program of computer instructions (PROG) 518, and a suitable wireless interface, such as radio frequency (RF) transceiver 512, for bidirectional wireless communications with the macro eNB 520 via one or more antennas.

The macro eNB 520 also includes a controller, such as a computer or a data processor (DP) 524, a computer-readable memory medium embodied as a memory (MEM) 526 that stores a program of computer instructions (PROG) 528, and a suitable wireless interface, such as RF transceiver 522, for communication with the UE 510 via one or more antennas. The macro eNB 520 is coupled via a data/control path 534 to the NCE 540. The path 534 may be implemented as an S1 interface. The macro eNB 520 may also be coupled to a pico eNB via data/control path 536, which may be implemented as an X2 interface.

The pico eNB 550 also includes a controller, such as a computer or a data processor (DP) 554, a computer-readable memory medium embodied as a memory (MEM) 556 that stores a program of computer instructions (PROG) 558, and a suitable wireless interface, such as RF transceiver 552, for communication with various UE (such as UE 510) via one or more antennas.

The NCE 540 includes a controller, such as a computer or a data processor (DP) 544, a computer-readable memory medium embodied as a memory (MEM) 546 that stores a program of computer instructions (PROG) 548.

At least one of the PROGs 528, 548 and 558 is assumed to include program instructions that, when executed by the associated DP, enable the device to operate in accordance with exemplary embodiments, as will be discussed below in greater detail.

That is, various exemplary embodiments may be implemented at least in part by computer software executable by the DP 524 of the macro eNB 520; by the DP 554 of the pico eNB 550; and/or by the DP 544 of the NCE 540, or by hardware, or by a combination of software and hardware (and firmware).

The macro eNB 520 and the pico eNB 550 may also include dedicated processors, for example ABS processor 525 and ABS processor 555. Similarly, the UE 510 may include a dedicated ABS processor 515.

In general, the various embodiments of the UE 510 can include, but are not limited to, cellular telephones, tablets having wireless communication capabilities, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs 516, 526, 546 and 556 may be of any type suitable to the local technical environment and may be implemented using any suitable data storage technology, such as semiconductor based memory devices, flash memory, magnetic memory devices and systems, optical memory devices and systems, fixed memory and removable memory. The DPs 514, 524, 544 and 544 may be of any type suitable to the local technical environment, and may include one or more of general purpose computers, special purpose computers, microprocessors, digital signal processors (DSPs) and processors based on a multicore processor architecture, as non-limiting examples. The wireless interfaces (e.g., RF transceivers 512, 522 and 552) may be of any type suitable to the local technical environment and may be implemented using any suitable communication technology such as individual transmitters, receivers, transceivers or a combination of such components.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although not limited thereto. While various aspects of the exemplary embodiments may be illustrated and described as block diagrams, flow charts, or using some other pictorial representation, it is well understood that these blocks, apparatus, systems, techniques or methods described herein may be implemented in, as nonlimiting examples, hardware, software, firmware, special purpose circuits or logic, general purpose hardware or controller or other computing devices, or some combination thereof.

It should thus be appreciated that at least some aspects of the exemplary embodiments may be practiced in various components such as integrated circuit chips and modules, and that the exemplary embodiments may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments.

An exemplary embodiment provides a method for inter-eNB signaling for co-channel cell deployments. The method includes receiving (such as by a receiver for example), at an underlying AP from an overlaying AP, first ABS information regarding a plurality of SFs. The first ABS information includes an identification of at least one mandatory ABS in the plurality of SFs. The method includes receiving (such as by a receiver for example), at the underlying AP from the overlaying AP, second ABS information regarding the plurality of SFs. The second ABS information includes an identification of at least one optional ABS in the plurality of SFs. The first ABS information and the second ABS information may be included in a single message or transmitted in separate massages. The method also includes scheduling (such as by a processor for example) the plurality of SFs for an underlying cell based at least in part on whether the at least one optional ABS is to be used as an ABS.

In a further exemplary embodiment of the method above, the method includes determining whether the at least one optional ABS is to be used as an ABS based at least in part on fast ABS information regarding the plurality of SFs. The fast ABS information may include an indication of a configuration and an indication of a number, N, of optional ABSs. The next N optional ABSs may then be configured as indicated. The configuration is a normal SFs configuration or a mandatory ABS configuration.

In another exemplary embodiment of any one of the methods above, the first ABS information includes a bit string indicating which SFs in the plurality of SFs are mandatory ABSs.

In a further exemplary embodiment of any one of the methods above, the second ABS information includes a bit string indicating which SFs in the plurality of SFs are optional ABSs.

In another exemplary embodiment of any one of the methods above, the first ABS information and the second ABS information are received using an X2 connection.

In a further exemplary embodiment of any one of the methods above, the method also includes sending underlying cell information to the overlaying AP. The underlying cell information may include cell load information, average channel condition information, a number of users, and/or an average proportional fair metric. Sending the underlying cell information may be performed in response to a significant change in the underlying cell information and/or periodically.

In another exemplary embodiment of any one of the methods above, scheduling the plurality of SFs for an underlying cell uses the at least one optional ABS as a normal SF in response to not receiving fast ABS information.

In a further exemplary embodiment of any one of the methods above, scheduling the plurality of SFs for an underlying cell uses the next N of the at least one optional ABS as a mandatory ABSs in response to receiving fast ABS information including an indication of a number, N.

Another exemplary embodiment provides a method for inter-eNB signaling for co-channel cell deployments. The method includes scheduling (such as by a processor for example) mandatory ABSs in a plurality of SFs and sending (such as by a transmitter for example), to an underlying AP from an overlaying AP, an indication of the mandatory ABSs. The method also includes scheduling (such as by a processor for example) optional ABSs in the plurality of SFs and sending (such as by a transmitter for example), to the underlying AP from the overlaying AP, second ABS information regarding the plurality of SFs. The second ABS information includes identification of at least one optional ABS in the plurality of SFs.

In a further exemplary embodiment of the method above, the first ABS information includes a bit string indicating which SFs in the plurality of SFs are mandatory ABSs.

In another exemplary embodiment of any one of the methods above, the second ABS information includes a bit string indicating which SFs in the plurality of SFs are optional ABSs.

In a further exemplary embodiment of any one of the methods above, the first ABS information and the second ABS information is sent using an X2 connection.

In another exemplary embodiment of any one of the methods above, the method also includes receiving, from the underlying AP, underlying cell information. The underlying cell information may include cell load information, average channel condition information, a number of users, and/or an average proportional fair metric. Scheduling the optional ABSs may be based on the underlying cell information.

In a further exemplary embodiment of any one of the methods above, the method includes determining a configuration for a number, N, of next optional ABSs. The configuration is a normal SFs configuration or a mandatory ABS configuration. The method also includes sending, to the underlying AP, an indication of the configuration and an indication of the number, N.

Another exemplary embodiment provides an apparatus for inter-eNB signaling for co-channel cell deployments. The apparatus includes at least one processor and at least one memory storing computer program code. The at least one memory and the computer program code are configured to, with the at least one processor, cause the apparatus to perform actions. The actions include to receive, at an underlying AP from an overlaying AP, first ABS information regarding a plurality of SFs. The first ABS information includes an identification of at least one mandatory ABS in the plurality of SFs. The actions include to receive, at the underlying AP from the overlaying AP, second ABS information regarding the plurality of SFs. The second ABS information includes an identification of at least one optional ABS in the plurality of SFs. The actions also include to schedule the plurality of SFs for an underlying cell based at least in part on whether the at least one optional ABS is to be used as an ABS.

In a further exemplary embodiment of the apparatus above, the actions include to determine whether the at least one optional ABS is to be used as an ABS based at least in part on fast ABS information regarding the plurality of SFs. The fast ABS information may include an indication of a configuration and an indication of a number, N, of optional ABSs The next N optional ABSs may then be configured as indicated. The configuration is a normal SFs configuration or a mandatory ABS configuration.

In another exemplary embodiment of any one of the apparatus above, the first ABS information includes a bit string indicating which SFs in the plurality of SFs are mandatory ABSs.

In a further exemplary embodiment of any one of the apparatus above, the second ABS information includes a bit string indicating which SFs in the plurality of SFs are optional ABSs.

In another exemplary embodiment of any one of the apparatus above, the first ABS information and the second ABS information are received using an X2 connection.

In a further exemplary embodiment of any one of the apparatus above, the actions also include to send underlying cell information to the overlaying AP. The underlying cell information may include cell load information, average channel condition information, a number of users, and/or an average proportional fair metric. Sending the underlying cell information may be performed in response to a significant change in the underlying cell information and/or periodically.

In another exemplary embodiment of any one of the apparatus above, scheduling the plurality of SFs for an underlying cell uses the at least one optional ABS as a normal SF in response to not receiving fast ABS information.

In a further exemplary embodiment of any one of the apparatus above, scheduling the plurality of SFs for an underlying cell uses the next N of the at least one optional ABS as a mandatory ABSs in response to receiving fast ABS information including an indication of a number, N.

In another exemplary embodiment of any one of the apparatus above, the apparatus is embodied in a mobile device.

In a further exemplary embodiment of any one of the apparatus above, the apparatus is embodied in an integrated circuit.

Another exemplary embodiment provides an apparatus for inter-eNB signaling for co-channel cell deployments. The apparatus includes at least one processor and at least one memory storing computer program code. The at least one memory and the computer program code are configured to, with the at least one processor, cause the apparatus to perform actions. The actions include to schedule mandatory ABSs in a plurality of SFs and to send, to an underlying AP from an overlaying AP, an indication of the mandatory ABSs. The actions also include to schedule optional ABSs in the plurality of SFs and to send, to the underlying AP from the overlaying AP, second ABS information regarding the plurality of SFs. The second ABS information includes identification of at least one optional ABS in the plurality of SFs.

In a further exemplary embodiment of the apparatus above, the first ABS information includes a bit string indicating which SFs in the plurality of SFs are mandatory ABSs.

In another exemplary embodiment of any one of the apparatus above, the second ABS information includes a bit string indicating which SFs in the plurality of SFs are optional ABSs.

In a further exemplary embodiment of any one of the apparatus above, the first ABS information and the second ABS information is sent using an X2 connection.

In another exemplary embodiment of any one of the apparatus above, the actions also include to receive, from the underlying AP, underlying cell information. The underlying cell information may include cell load information, average channel condition information, a number of users, and/or an average proportional fair metric. Scheduling the optional ABSs may be based on the underlying cell information.

In a further exemplary embodiment of any one of the apparatus above, the actions include to determine a configuration for a number, N, of next optional ABSs. The configuration is a normal SFs configuration or a mandatory ABS configuration. The actions also include to send, to the underlying AP, an indication of the configuration and an indication of the number, N.

In another exemplary embodiment of any one of the apparatus above, the apparatus is embodied in a mobile device.

In a further exemplary embodiment of any one of the apparatus above, the apparatus is embodied in an integrated circuit.

Another exemplary embodiment provides a computer readable medium for inter-eNB signaling for co-channel cell deployments. The computer readable medium (such as MEM 556 for example) is tangibly encoded with a computer program (such as PROG 558 for example) executable by a processor (such as DP 554 for example) to perform actions. The actions include receiving, at an underlying AP from an overlaying AP, first ABS information regarding a plurality of SFs. The first ABS information includes an identification of at least one mandatory ABS in the plurality of SFs. The actions include receiving, at the underlying AP from the overlaying AP, second ABS information regarding the plurality of SFs. The second ABS information includes an identification of at least one optional ABS in the plurality of SFs. The actions also include scheduling the plurality of SFs for an underlying cell based at least in part on whether the at least one optional ABS is to be used as an ABS.

In a further exemplary embodiment of the computer readable medium above, the actions include determining whether the at least one optional ABS is to be used as an ABS based at least in part on fast ABS information regarding the plurality of SFs. The fast ABS information may include an indication of a configuration and an indication of a number, N, of optional ABSs The next N optional ABSs may then be configured as indicated. The configuration is a normal SFs configuration or a mandatory ABS configuration.

In another exemplary embodiment of any one of the computer readable media above, the first ABS information includes a bit string indicating which SFs in the plurality of SFs are mandatory ABSs.

In a further exemplary embodiment of any one of the computer readable media above, the second ABS information includes a bit string indicating which SFs in the plurality of SFs are optional ABSs.

In another exemplary embodiment of any one of the computer readable media above, the first ABS information and the second ABS information are received using an X2 connection.

In a further exemplary embodiment of any one of the computer readable media above, the actions also include sending underlying cell information to the overlaying AP. The underlying cell information may include cell load information, average channel condition information, a number of users, and/or an average proportional fair metric. Sending the underlying cell information may be performed in response to a significant change in the underlying cell information and/or periodically.

In another exemplary embodiment of any one of the computer readable media above, scheduling the plurality of SFs for an underlying cell uses the at least one optional ABS as a normal SF in response to not receiving fast ABS information.

In a further exemplary embodiment of any one of the computer readable media above, scheduling the plurality of SFs for an underlying cell uses the next N of the at least one optional ABS as a mandatory ABSs in response to receiving fast ABS information including an indication of a number, N.

In another exemplary embodiment of any one of the computer readable media above, the computer readable medium is a non-transitory computer readable medium (e.g., CD-ROM, RAM, flash memory, etc.).

In a further exemplary embodiment of any one of the computer readable media above, the computer readable medium is a storage medium.

Another exemplary embodiment provides a computer readable medium for inter-eNB signaling for co-channel cell deployments. The computer readable medium (such as MEM 526 for example) is tangibly encoded with a computer program (such as PROG 528 for example) executable by a processor (such as DP 524 for example) to perform actions. The actions include scheduling mandatory ABSs in a plurality of SFs and sending, to an underlying AP from an overlaying AP, an indication of the mandatory ABSs.

The actions also include scheduling optional ABSs in the plurality of SFs and sending, to the underlying AP from the overlaying AP, second ABS information regarding the plurality of SFs. The second ABS information includes identification of at least one optional ABS in the plurality of SFs.

In a further exemplary embodiment of the computer readable medium above, the first ABS information includes a bit string indicating which SFs in the plurality of SFs are mandatory ABSs.

In another exemplary embodiment of any one of the computer readable media above, the second ABS information includes a bit string indicating which SFs in the plurality of SFs are optional ABSs.

In a further exemplary embodiment of any one of the computer readable media above, the first ABS information and the second ABS information is sent using an X2 connection.

In another exemplary embodiment of any one of the computer readable media above, the actions also include receiving, from the underlying AP, underlying cell information. The underlying cell information may include cell load information, average channel condition information, a number of users, and/or an average proportional fair metric. Scheduling the optional ABSs may be based on the underlying cell information.

In a further exemplary embodiment of any one of the computer readable media above, the actions include determining a configuration for a number, N, of next optional ABSs. The configuration is a normal SFs configuration or a mandatory ABS configuration. The actions also include sending, to the underlying AP, an indication of the configuration and an indication of the number, N.

In another exemplary embodiment of any one of the computer readable media above, the computer readable medium is a non-transitory computer readable medium (e.g., CD-ROM, RAM, flash memory, etc.).

In a further exemplary embodiment of any one of the computer readable media above, the computer readable medium is a storage medium.

Another exemplary embodiment provides an apparatus for inter-eNB signaling for co-channel cell deployments. The apparatus includes means for receiving (such as a receiver for example), at an underlying AP from an overlaying AP, first ABS information regarding a plurality of SFs. The first ABS information includes an identification of at least one mandatory ABS in the plurality of SFs. The apparatus includes means for receiving (such as a receiver for example), at the underlying AP from the overlaying AP, second ABS information regarding the plurality of SFs. The second ABS information includes an identification of at least one optional ABS in the plurality of SFs.

The apparatus also includes means for scheduling (such as a processor for example) the plurality of SFs for an underlying cell based at least in part on whether the at least one optional ABS is to be used as an ABS.

In a further exemplary embodiment of the apparatus above, the apparatus includes means for determining whether the at least one optional ABS is to be used as an ABS based at least in part on fast ABS information regarding the plurality of SFs. The fast ABS information may include an indication of a configuration and an indication of a number, N, of optional ABSs The next N optional ABSs may then be configured as indicated. The configuration is a normal SFs configuration or a mandatory ABS configuration.

In another exemplary embodiment of any one of the apparatus above, the first ABS information includes a bit string indicating which SFs in the plurality of SFs are mandatory ABSs.

In a further exemplary embodiment of any one of the apparatus above, the second ABS information includes a bit string indicating which SFs in the plurality of SFs are optional ABSs.

In another exemplary embodiment of any one of the apparatus above, the first ABS information and the second ABS information are received using an X2 connection.

In a further exemplary embodiment of any one of the apparatus above, the apparatus also includes means for sending underlying cell information to the overlaying AP. The underlying cell information may include cell load information, average channel condition information, a number of users, and/or an average proportional fair metric. Sending the underlying cell information may be performed in response to a significant change in the underlying cell information and/or periodically.

In another exemplary embodiment of any one of the apparatus above, scheduling the plurality of SFs for an underlying cell uses the at least one optional ABS as a normal SF in response to not receiving fast ABS information.

In a further exemplary embodiment of any one of the apparatus above, scheduling the plurality of SFs for an underlying cell uses the next N of the at least one optional ABS as a mandatory ABSs in response to receiving fast ABS information including an indication of a number, N.

Another exemplary embodiment provides a apparatus for inter-eNB signaling for co-channel cell deployments. The apparatus includes means for scheduling (such as a processor for example) mandatory ABSs in a plurality of SFs and means for sending (such as a transmitter for example), to an underlying AP from an overlaying AP, an indication of the mandatory ABSs. The apparatus also includes means for scheduling (such as a processor for example) optional ABSs in the plurality of SFs and means for sending (such as a transmitter for example), to the underlying AP from the overlaying AP, second ABS information regarding the plurality of SFs. The second ABS information includes identification of at least one optional ABS in the plurality of SFs.

In a further exemplary embodiment of the apparatus above, the first ABS information includes a bit string indicating which SFs in the plurality of SFs are mandatory ABSs.

In another exemplary embodiment of any one of the apparatus above, the second ABS information includes a bit string indicating which SFs in the plurality of SFs are optional ABSs.

In a further exemplary embodiment of any one of the apparatus above, the first ABS information and the second ABS information is sent using an X2 connection.

In another exemplary embodiment of any one of the apparatus above, the apparatus also includes means for receiving, from the underlying AP, underlying cell information. The underlying cell information may include cell load information, average channel condition information, a number of users, and/or an average proportional fair metric. Scheduling the optional ABSs may be based on the underlying cell information.

In a further exemplary embodiment of any one of the apparatus above, the apparatus includes means for determining a configuration for a number, N, of next optional ABSs. The configuration is a normal SFs configuration or a mandatory ABS configuration. The apparatus also includes means for sending, to the underlying AP, an indication of the configuration and an indication of the number, N.

Further exemplary embodiments are now described. Example 1. An apparatus comprising: means for receiving, at an underlying access point from an overlaying access point, first almost-blank subframe information regarding a plurality of subframes, wherein the first almost-blank subframe information includes an identification of at least one mandatory almost-blank subframe in the plurality of subframes; means for receiving, at the underlying access point from the overlaying access point, second almost-blank subframe information regarding the plurality of subframes, wherein the second almost-blank subframe information includes an identification of at least one optional almost-blank subframe in the plurality of subframes, wherein the optional almost-blank subframes are to be used as one of normal subframes or mandatory almost-blank subframes by the overlaying and underlying access points; and means for scheduling the plurality of subframes for the underlying cell based at least in part on whether the at least one optional almost-blank subframe is to be used as an almost-blank subframe.

Example 2. The apparatus of example 1, wherein the first almost-blank subframe information and the second almost-blank subframe information are received in a single message or received in separate massages. Example 3. The apparatus of any of examples 1 or 2, where the first almost-blank subframe information comprises information indicating which subframes in the plurality of subframes are mandatory almost-blank subframes.

Example 4. The apparatus of any of examples 1 to 3, where the second almost-blank subframe information comprises information indicating which subframes in the plurality of subframes are optional almost-blank subframes. Example 5. The apparatus of any of examples 1 to 4, where, in response to not receiving additional almost-blank subframe information, the means for scheduling the plurality of subframes for an underlying cell uses the at least one optional almost-blank subframe as a normal subframe. Example 6. The apparatus of example 4, wherein: the apparatus further comprises means for receiving a number, N, of optional almost-blank subframes; and the means for scheduling further comprises means for scheduling the plurality of subframes for the underlying cell by scheduling subframes as almost-blank subframes for a next N consecutive subframes of the at least one optional almost-blank subframes indicated by the second almost-blank subframe information.

Example 7. The apparatus of any of examples 1 to 6, further comprising means for sending underlying cell information to the overlaying access point. Example 8. The apparatus of example 7, where the underlying cell information comprises one or more of the following: cell load information, average channel condition information, a number of users, or an average proportional fair metric. Example 9. The apparatus of any of examples 7 or 8, where the sending the underlying cell information is performed in response to a significant change in the underlying cell information.

Example 10. The apparatus of any of examples 7 or 8, where sending the underlying cell information is performed periodically. Example 11. The apparatus of any of examples 1 to 10, wherein the apparatus further comprises means for using the at least one optional almost-blank subframe as an almost-blank subframe at least by transmitting to or receiving from user equipment during the almost-blank subframe.

Example 12. A apparatus, comprising: means for scheduling mandatory almost-blank subframes in a plurality of subframes; means for sending, to an underlying access point from an overlaying access point, first almost-blank subframe information regarding the plurality of subframes, wherein the first almost-blank subframe information comprises an identification of the mandatory almost-blank subframes; means for scheduling optional almost-blank subframes in the plurality of subframes, wherein the optional almost-blank subframes are to be used as one of normal subframes or mandatory almost-blank subframes by the overlaying and underlying access points; and means for sending, to the underlying access point from the overlaying access point, second almost-blank subframe information regarding the plurality of subframes, where the second almost-blank subframe information comprises identification of at least one optional almost-blank subframe in the plurality of subframes.

Example 13. The apparatus of example 12, where the first almost-blank subframe information comprises information indicating which subframes in the plurality of subframes are mandatory almost-blank subframes. Example 14. The apparatus of any of examples 12 or 13, where the second almost-blank subframe information comprises information indicating which subframes in the plurality of subframes are optional almost- blank subframes.

Example 15. The apparatus of example 14, wherein the apparatus further comprises: means for determining a number, N, of optional almost-blank subframes to be used by the underlying cell as scheduled almost-blank subframes for N consecutive subframes of the at least one optional almost-blank subframes indicated by the second almost-blank subframe information; and means for sending an indication of the number, N, from the overlaying cell to the underlying cell. Example 16. The apparatus of any of examples 12 to 15, further comprising means for receiving, from the underlying access point, underlying cell information. Example 17. The apparatus of example 16, where the underlying cell information comprises at least one of: cell load information, average channel condition information, a number of users, and an average proportional fair metric.

Example 18. The apparatus of any of examples 16 or 17, where scheduling the optional almost-blank subframes is based at least in part on the underlying cell information. Example 19. The apparatus of any of examples 16 to 18, further comprising: means for using the mandatory almost-blank subframes in the plurality of subframes; and means for using individual ones of the optional almost-blank subframes in the plurality of subframes as one of a normal subframe or an almost-blank subframe.

Various modifications and adaptations to the foregoing exemplary embodiments may become apparent to those skilled in the relevant arts in view of the foregoing description, when read in conjunction with the accompanying drawings. However, any and all modifications will still fall within the scope of the non-limiting and exemplary embodiments.

For example, while the exemplary embodiments have been described above in the context of the E-UTRAN (UTRAN-LTE) system, it should be appreciated that the exemplary embodiments are not limited for use with only this one particular type of wireless communication system, and that they may be used to advantage in other wireless communication systems such as for example (WLAN, UTRAN, GSM as appropriate).

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters are not intended to be limiting in any respect, as these parameters may be identified by any suitable names.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
3GPP third generation partnership project
ABS almost blank subframe
AP access point, such as an eNB, RRH, etc.
BS base station
CQI channel quality indicator
CSI channel state information
DL downlink (from base station to UE)
eICIC enhanced ICIC
eNB E-UTRAN Node B (evolved Node B, a base station)
EPC evolved packet core
E-UTRAN evolved UTRAN (LTE)
FDD frequency division duplex
FeICIC further eICIC
ICIC inter-cell interference coordination
IE information element
LP-ABS low power ABS
LTE long term evolution of UTRAN (E-UTRAN)
Node B base station
PF proportional fair
RRH remote radio head
SF subframe
SFN subframe number
TDD time-division duplex
TTI transmission time interval
UE user equipment, such as a mobile station or mobile terminal
UTRAN universal terrestrial radio access network

1. A method, comprising:
receiving, at an underlying access point from an overlaying access point, first almost-blank subframe information regarding a plurality of subframes, wherein the first almost-blank subframe information includes an identification of at least one mandatory almost-blank subframe in the plurality of subframes;
receiving, at the underlying access point from the overlaying access point, second almost-blank subframe information regarding the plurality of subframes, wherein the second almost-blank subframe information includes an identification of at least one optional almost-blank subframe in the plurality of subframes, wherein the optional almost-blank subframes are to be used as one of normal subframes or mandatory almost-blank subframes by the overlaying and underlying access points; and
scheduling the plurality of subframes for the underlying cell based at least in part on whether the at least one optional almost-blank subframe is to be used as an almost- blank subframe.

2. (canceled)

3. The method of claim 1, where the first almost-blank subframe information comprises information indicating which subframes in the plurality of subframes are mandatory almost-blank subframes.

4. The method of claim 1, where the second almost-blank subframe information comprises information indicating which subframes in the plurality of subframes are optional almost-blank subframes.

5. The method of claim 1, where, in response to not receiving additional almost-blank subframe information, scheduling the plurality of subframes for an underlying cell uses the at least one optional almost-blank subframe as a normal subframe.

6. The method of claim 4, wherein:
the method further comprises receiving a number, N, of optional almost-blank subframes; and
scheduling further comprises scheduling the plurality of subframes for the underlying cell by scheduling subframes as almost-blank subframes for a next N consecutive subframes of the at least one optional almost-blank subframes indicated by the second almost-blank subframe information.

7. The method of claim 1, further comprising sending underlying cell information to the overlaying access point.

8. The method of claim 7, where the underlying cell information comprises one or more of the following: cell load information, average channel condition information, a number of users, or an average proportional fair metric.

9. (canceled)

10. (canceled)

11. The method of claim 1, wherein the method further comprises using the at least one optional almost-blank subframe as an almost-blank subframe at least by transmitting to or receiving from user equipment during the almost-blank subframe.

12. An apparatus comprising:
means for receiving, at an underlying access point from an overlaying access point, first almost-blank subframe information regarding a plurality of subframes, wherein the first almost-blank subframe information includes an identification of at least one mandatory almost-blank subframe in the plurality of subframes;
means for receiving, at the underlying access point from the overlaying access point, second almost-blank subframe information regarding the plurality of subframes, wherein the second almost-blank subframe information includes an identification of at least one optional almost-blank subframe in the plurality of subframes, wherein the optional almost-blank subframes are to be used as one of normal subframes or mandatory almost-blank subframes by the overlaying and underlying access points; and
means for scheduling the plurality of subframes for the underlying cell based at least in part on whether the at least one optional almost-blank subframe is to be used as an almost-blank subframe.

13. (canceled)

14. A method, comprising:
scheduling mandatory almost-blank subframes in a plurality of subframes;
sending, to an underlying access point from an overlaying access point, first almost-blank subframe information regarding the plurality of subframes, wherein the first almost-blank subframe information comprises an identification of the mandatory almost-blank subframes;
scheduling optional almost-blank subframes in the plurality of subframes, wherein the optional almost-blank subframes are to be used as one of normal subframes or mandatory almost-blank subframes by the overlaying and underlying access points; and
sending, to the underlying access point from the overlaying access point, second almost-blank subframe information regarding the plurality of subframes, where the second almost-blank subframe information comprises identification of at least one optional almost-blank subframe in the plurality of subframes.

15. The method of claim 14, where the first almost-blank subframe information comprises information indicating which subframes in the plurality of subframes are mandatory almost-blank subframes.

16. The method of claim 14, where the second almost-blank subframe information comprises information indicating which subframes in the plurality of subframes are optional almost-blank subframes.

17. The method of claim 16, wherein the method further comprises:
determining a number, N, of optional almost-blank subframes to be used by the underlying cell as scheduled almost-blank subframes for N consecutive subframes of the at least one optional almost-blank subframes indicated by the second almost-blank subframe information; and
sending an indication of the number, N, from the overlaying cell to the underlying cell.

18. The method of claim 14, further comprising receiving, from the underlying access point, underlying cell information.

19. The method of claim 18, where the underlying cell information comprises at least one of: cell load information, average channel condition information, a number of users, and an average proportional fair metric.

20. The method of claim 18, where scheduling the optional almost-blank subframes is based at least in part on the underlying cell information.

21. (canceled)

22. An apparatus comprising:
means for scheduling mandatory almost-blank subframes in a plurality of subframes;
means for sending, to an underlying access point from an overlaying access point, first almost-blank subframe information regarding the plurality of subframes, wherein the first almost-blank subframe information comprises an identification of the mandatory almost-blank subframes;
means for scheduling optional almost-blank subframes in the plurality of subframes, wherein the optional almost-blank subframes are to be used as one of normal subframes or mandatory almost-blank subframes by the overlaying and underlying access points; and
means for sending, to the underlying access point from the overlaying access point, second almost-blank subframe information regarding the plurality of subframes, where the second almost-blank subframe information comprises identification of at least one optional almost-blank subframe in the plurality of subframes.

23. (canceled)

24. (canceled)

25. A computer program product comprising computer executable code which when run causes the method of claim 1 to be performed.

26. (canceled)
